(19) United States
(12) Patent Application Publication
(10) Pub. No.: US 2012/0062738 A1
(43) Pub. Date: Mar. 15, 2012

(54) REMOVAL/ABANDONMENT DETERMINATION DEVICE AND REMOVAL/ABANDONMENT DETERMINATION METHOD

(75) Inventors: Kentarou Ohkawa, Fukuoka (JP); Kenichiro Sugimoto, Fukuoka (JP); Takayuki Haraguchi, Fukuoka (JP)

(73) Assignee: PANASONIC CORPORATION, Osaka (JP)

(21) Appl. No.: 13/320,964

(22) PCT Filed: Mar. 2, 2010
(86) PCT No.: PCT/JP2010/001430

§ 371 Date: Nov. 17, 2011

(51) Int. Cl. H04N 7/18

(52) U.S. Cl. 348/143; 348/E07.085

(57) ABSTRACT

A removal/abandonment determination device includes: a sampling point setting unit configured to set sampling points on a boundary line of an object; a luminance determination unit configured to determine whether a ratio of an area having the same luminance in a peripheral region of each of the sampling points is a first certain value or more; and a removal/abandonment determination unit. The removal/abandonment determination unit determines that the object is removed when the sampling points of which the ratio is determined as being the first certain value or more are a second certain value or more, and determines that the object is abandoned when the sampling points of which the ratio is determined as being the first certain value or more are less than the second certain value.

### TECHNICAL FIELD

The present invention relates to a removal/abandonment determination device and a removal/abandonment determination method suitable for use in a monitoring system.

### BACKGROUND ART

A monitoring system generally includes a plurality of monitoring cameras and a video recorder for recording video from each of the plurality of monitoring cameras. A conventional monitoring system includes a system having an automatic movement detection function for detecting an intruder etc. by detecting a change in luminance of an image, or a system having an unmoving object detection function in addition to the automatic detection function. The unmoving object detection function is a function of detecting whether an object is abandoned or removed when a change from a previously stored luminance state continues for a certain time by monitoring a change in information about luminance of an image.

For example, in an unmoving object detection function of an image monitoring apparatus disclosed in Patent Reference 1, when an intrusion object is detected within a set detection region, an obtained image just before the detection is stored, and when the intrusion object goes out of the detection region, it is determined whether the intrusion object gives a change in the image in the detection region by comparing the stored image with a subsequent obtained image.

### RELATED ART DOCUMENTS

### Patent Documents

Patent Reference 1: JP-A-5-007363

### SUMMARY OF THE INVENTION

### Problem to be Solved by the Invention

However, the conventional unmoving object detection function merely monitors a change in information about luminance, thereby having a problem of not being possible to accurately identify whether the object is abandoned or removed.

The invention has been made in view of such circumstances, and an object thereof is to provide a removal/abandonment determination device and a removal/abandonment determination method capable of accurately discriminating between removal and abandonment of an object.

### Means for Solving the Problem

A removal/abandonment determination device of the invention includes: sampling point setting means for setting a plurality of sampling points on a boundary line of an object detected based on an input image; luminance determination means for determining whether a ratio of an area having the same luminance in a peripheral region of each of the plurality of sampling points is a first certain value or more; and removal/abandonment determination means for determining that the object is removed when the sampling points of which the ratio of the area having the same luminance in the peripheral region is determined as being the first certain value or more are a second certain value or more, and for determining that the object is abandoned when the sampling points of which the ratio of the area having the same luminance in the peripheral region is determined as being the first certain value or more are less than the second certain value.

According to the configuration described above, the plurality of sampling points are set on the boundary line of the object detected based on the input image and it is determined whether a ratio of an area having the same luminance in the peripheral region of each of the sampling points is the first certain value or more, and when the sampling points of which the area having the same luminance in the peripheral region is determined as being the first certain value or more are the second certain value or more, it is determined that the object is removed, and when the sampling points of which the area having the same luminance in the peripheral region is determined as being the first certain value or more are less than the second certain value, it is determined that the object is abandoned, so that it is possible to accurately identify whether the object is removed or abandoned. For example, the peripheral region of the sampling point arbitrarily set on the boundary line of the detected object is equally divided into eight pieces and when the such sampling points in which six or more pieces of the eight pieces (75% or more) have the same luminance information are half or more (50% or more), it is determined that the object is removed, and otherwise, it is determined that the object is abandoned.

A removal/abandonment determination method of the invention includes: a sampling point setting step of setting a plurality of sampling points on a boundary line of an object detected based on an input image; a luminance determination step of determining whether a ratio of an area having the same luminance in a peripheral region of each of the plurality of sampling points is a first certain value or more; and a removal/abandonment determination step of determining that the object is removed when the sampling points of which the ratio of the area having the same luminance in the peripheral region is determined as being the first certain value or more are a second certain value or more, and of determining that the object is abandoned when the sampling points of which the ratio of the area having the same luminance in the peripheral region is determined as being the first certain value or more are less than the second certain value.

According to the method described above, the plurality of sampling points are set on the boundary line of the object detected based on the input image and it is determined whether a ratio of an area having the same luminance in the peripheral region of each of the sampling points is the first certain value or more, and when the sampling points of which the area having the same luminance in the peripheral region is determined as being the first certain value or more are the second certain value or more, it is determined that the object is removed, and when the sampling points of which the area having the same luminance in the peripheral region is determined as being the first certain value or more are less than the second certain value, it is determined that the object is abandoned, so that it is possible to accurately identify whether the object is removed or abandoned.

A monitoring camera system of the invention includes: a monitoring camera including: a video signal input unit configured to obtain a video signal; and an unmoving object detection unit configured to continuously detect a state change in the video signal from the video signal input unit for a certain time so as to perform unmoving object detection of abandonment or removal, and to output an alarm; and a video recorder including: sampling setting means for receiving the alarm from the unmoving object detection unit and for setting a plurality of sampling points on a boundary line of an object detected based on an input image from the monitoring camera; luminance determination means for determining whether a ratio of an area having the same luminance in a peripheral region of each of the sampling points is a first certain value or more; and removal/abandonment determination means for determining that the object is abandoned when the sampling points of which the ratio of the area having the same luminance in the peripheral region is determined as being the first certain value or more are less than a second certain value.

According to the configuration described above, in the monitoring camera side, the state change in the obtained video signal is detected continuously for the certain time and the unmoving object detection of abandonment or removal is performed and the alarm is output. In the video recorder side, the alarm is received and the plurality of sampling points are set on the boundary line of the object detected based on the input image from the monitoring camera and it is determined whether a ratio of an area having the same luminance in the peripheral region of each of the sampling points is the first certain value or more, and when the sampling points of which the area having the same luminance in the peripheral region is determined as being the first certain value or more are less than the second certain value, it is determined that the object is abandoned. Consequently, it is possible to accurately identify whether the object is removed or abandoned.

### Advantages of the Invention

The plurality of sampling points are set on the boundary line of the object detected based on the input image and it is determined whether a ratio of an area having the same luminance in the peripheral region of each of the sampling points is the first certain value or more, and when the sampling points of which the area having the same luminance in the peripheral region is determined as being the first certain value or more are the second certain value or more, it is determined that the object is removed, and when the sampling points of which the area having the same luminance in the peripheral region is determined as being the first certain value or more are less than the second certain value, it is determined that the object is abandoned, so that it is possible to accurately identify whether the object is removed or abandoned.

### BRIEF DESCRIPTION OF THE DRAWINGS

FIG. 1 is a block diagram showing a schematic configuration of an object removal/abandonment determination device according to one embodiment of the invention.

FIGS. 2(a) to 2(d) are diagrams explaining object removal/abandonment determination processing of the object removal/abandonment determination device of FIG. 1.

FIG. 3 is a flowchart explaining the object removal/abandonment determination processing of the object removal/abandonment determination device of FIG. 1.

### MODE FOR CARRYING OUT THE INVENTION

A preferred embodiment for carrying out the invention will hereinafter be described in detail with reference to the drawings.

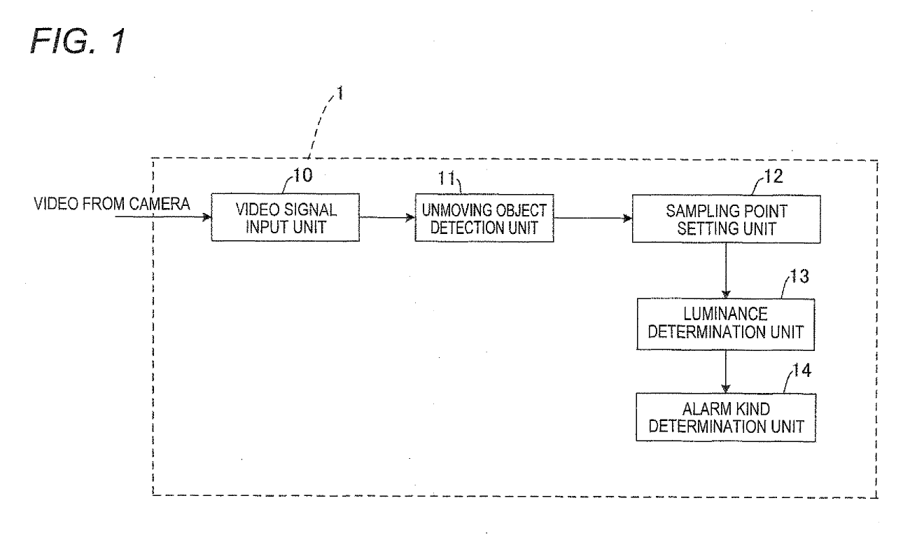

FIG. 1 is a block diagram showing a schematic configuration of an object removal/abandonment determination device according to one embodiment of the invention. The object removal/abandonment determination device of the present embodiment is a device applied to a video recorder of a monitoring system that includes a monitoring camera and the video recorder for recording video from the monitoring camera.

In FIG. 1, the object removal/abandonment determination device 1 of the embodiment includes a video signal input unit 10, an unmoving object detection unit 11, a sampling point setting unit 12, a luminance determination unit 13 and an alarm kind determination unit 14. The video signal input unit 10 obtains a video signal output from a monitoring camera (not shown). The unmoving object detection unit 11 continuously detects a state change in luminance for a certain time from the video signal obtained by the video signal input unit 10 and performs unmoving object detection of abandonment or removal. In addition, the method disclosed in Patent Document 1 described above may be used in the unmoving object detection.

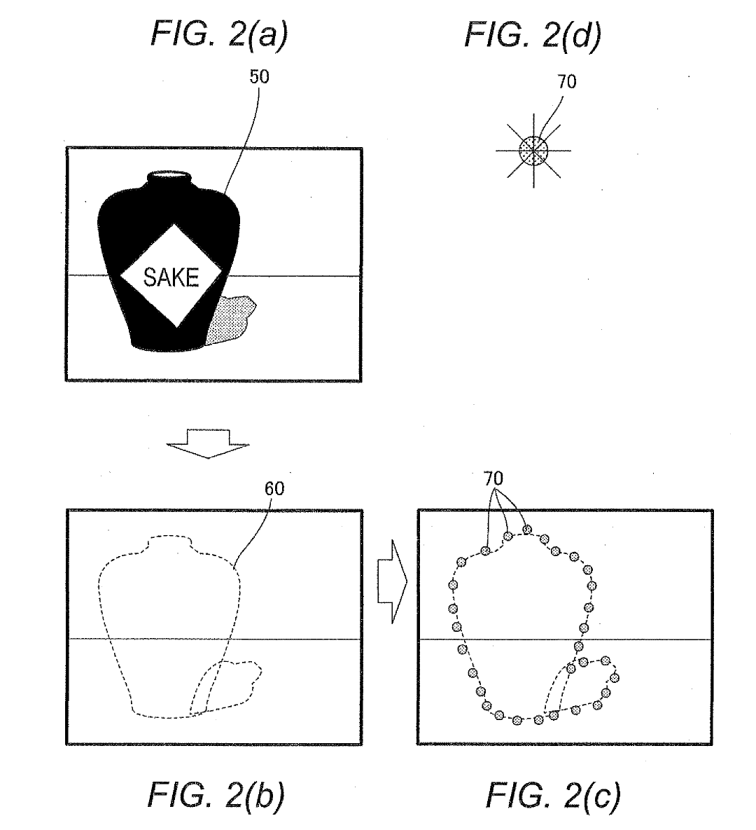

The sampling point setting unit 12 sets any sampling points on a boundary line of the object detected by the unmoving object detection unit 11. For example, by detecting an unmoving object in an image shown in FIG. 2(a), an object (image of a bottle written as “sake”) 50 is detected as the unmoving object. Then, the image of the object 50 in which the unmoving object is detected is input to the sampling point setting unit 12, and a boundary line 60 is set as shown in FIG. 2(b). Thereafter, a plurality of sampling points 70 (thirty points, in FIG. 2) are set on the boundary line 60 as shown in FIG. 2(c).

The luminance determination unit 13 determines whether an area having the same luminance in a peripheral region of each of the plurality of sampling points 70 set by the sampling point setting unit 12 is a first certain value or more (for example, 75% or more), and further determines whether the sampling points of which the ratio of the area having the same luminance in the peripheral region is the first certain value or more are a second certain value or more (for example, 50% or more), and determines that the object is removed when the sampling points is the second certain value or more and determines that the object is abandoned when the number of sampling points are less than the second certain value. For example, as shown in FIG. 2(d), the periphery of one sampling point 70 is equally divided into eight pieces and when the sampling points in which six or more pieces of the eight pieces have the same luminance are half or more, it is determined that the object is removed, and otherwise, it is determined that the object is abandoned. The alarm kind determination unit 14 determines an alarm kind according to a result (the object is removed or abandoned) of determination of the luminance determination unit 13, and outputs that result as sound data or display data.

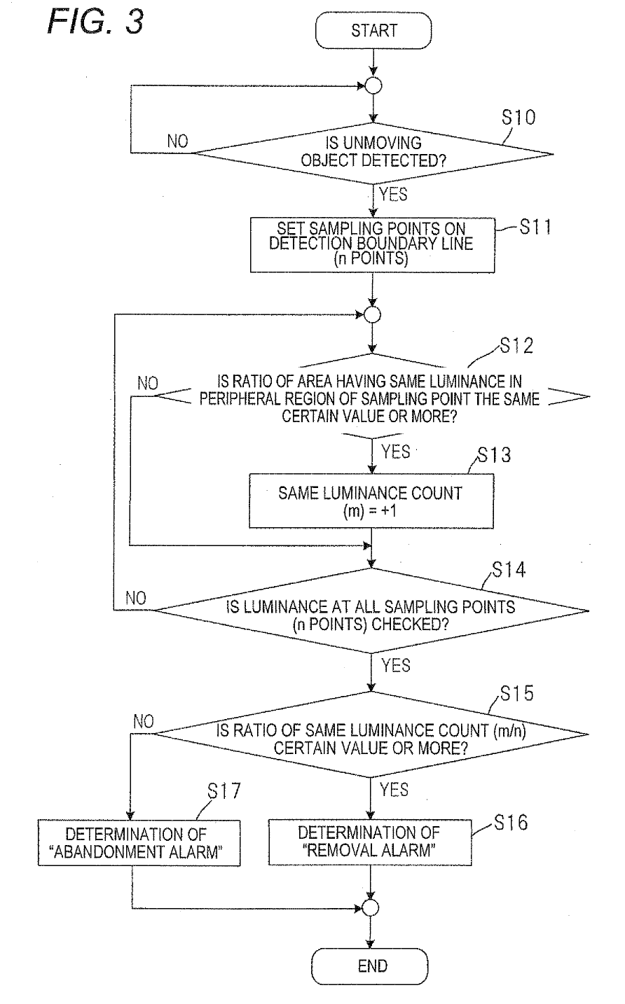

FIG. 3 is a flowchart showing an operation of the object removal/abandonment determination device 1 of the embodiment. In FIG. 3, it is first determined whether an unmoving object is detected based on the input image (step S10), and when the unmoving object is not detected, this step is repeated until the unmoving object is detected. When the unmoving object is detected, a detection boundary line is set, and n sampling points are set on the set detection boundary line (step S11). After the n sampling points are set on the detection boundary line, luminance at the first sampling point is checked. That is, it is determined whether a ratio of an area having the same luminance in a peripheral region of the sampling point is a first certain value or more (for example, 75% or more) (step S12), and when the ratio of the area having the same luminance in the peripheral region is the first certain value or more, a same luminance count (m) is incremented by “+1” (step S13). That is, it is considered that there is one sampling point of which the ratio of the area having the same luminance in the peripheral region is the first certain value or more, and the count value is incremented by 1.

Next, it is determined whether luminance at all the sampling points are checked (step S14), and when the luminance at all the sampling points are not checked, the flowchart returns to step S12, and luminance at the next sampling point is checked.

On the other hand, when the ratio of the area having the same luminance in the peripheral region is not the first certain value or more in the determination of step S12, the same luminance count processing of step S13 is not performed and the determination of step S14 is made. After checking the luminance at all the sampling points set on the detection boundary line, it is determined whether a ratio of the same luminance count (m/n) is a second certain value or more (for example, 50% or more) (step S15). When the ratio of the same luminance count is the second certain value or more, a determination of a “removal alarm” is made (step S16). When the ratio of the same luminance count is not the second certain value or more, a determination of an “abandonment alarm” is made (step S17). After processing of step S16 or step S17 is performed, the present processing is ended.

According to the removal/abandonment determination device 1 of the embodiment, the plurality of sampling points are set on the boundary line of the object detected based on the input image and it is determined whether the ratio of the area having the same luminance in the peripheral region of each of the set sampling points is the first certain value or more (for example, 75% or more), and when the sampling points of which the area having the same luminance in the peripheral region is determined as being the first certain value or more are the second certain value or more (for example, 50% or more), it is determined that the object is removed, and when the sampling points of which the area having the same luminance in the peripheral region is determined as being the first certain value or more (for example, 75% or more) are less than the second certain value (for example, less than 50%), it is determined that the object is abandoned, so that it is possible to accurately identify whether the object is removed or abandoned.

Of the units configuring the object removal/abandonment determination device 1 of the embodiment, the video signal input unit 10 and the unmoving object detection unit 11 may be provided in a monitoring camera. In other words, the unmoving object detection unit of the monitoring camera does not identify removal and abandonment and outputs an alarm to the video recorder when the object is removed or abandoned. This is implemented to prevent a situation in which an image at the moment that the object is removed or abandoned cannot be recorded in the video recorder which receives the alarm because when the monitoring camera identifies the removal and abandonment, it takes time to output the alarm. On the other hand, the video recorder has only to perform processing of detection of identify removal and abandonment by receiving the alarm of removal or abandonment from the monitoring camera, so that a load of the processing can be reduced.

The invention has been described in detail with reference to the specific embodiment, but it is apparent to those skilled in the art that various changes or modifications may be made without departing from the spirit and scope of the invention.

The present application is based on Japanese patent application (patent application No. 2009-120931) filed on May 19, 2009, and the contents of which are hereby incorporated by reference.

### INDUSTRIAL APPLICABILITY

The invention has advantages capable of accurately identifying removal and abandonment of an object, and can be applied to a monitoring system, etc.

### DESCRIPTION OF REFERENCE SIGNS

1: OBJECT REMOVAL/ABANDONMENT DETERMINATION DEVICE
10: VIDEO SIGNAL INPUT UNIT
11: UNMOVING OBJECT DETECTION UNIT
12: SAMPLING POINT SETTING UNIT
13: LUMINANCE DETERMINATION UNIT
14: ALARM KIND DETERMINATION UNIT

1. (canceled)

2. (canceled)

3. A monitoring camera system comprising:
a monitoring camera comprising:
a video signal input unit configured to obtain a video signal; and
an unmoving object detection unit configured to continuously detect a state change in the video signal from the video signal input unit for a certain time so as to perform unmoving object detection of abandonment or removal, and to output an alarm when the abandonment or removal is detected; and
a video recorder comprising:
a sampling setting unit configured to set a plurality of sampling points on a boundary line of an object detected based on an input image from the monitoring camera when the alarm is received from the unmoving object detection unit;
a luminance determination unit configured to determine whether a ratio of an area having the same luminance in a peripheral region of each of the sampling points is a first certain value or more; and
a removal/abandonment determination unit configured to determine that the object is abandoned when the number of sampling points of which the ratio of the area having the same luminance in the peripheral region is determined as being the first certain value or more is less than a second certain value.
